(19) United States
(12) Patent Application Publication
(10) Pub. No.: US 2026/0044897 A1
(43) Pub. Date: Feb. 12, 2026

(54) SYSTEMS AND METHODS FOR PRICE DISCOVERY OFFERING

(71) Applicant: JPMORGAN CHASE BANK, N.A., New York, NY (US)

(72) Inventor: Catherine GUAN, New York, NY (US)

(21) Appl. No.: 19/293,453

(22) Filed: Aug. 7, 2025

Related U.S. Application Data
(60) Provisional application No. 63/680,350, filed on Aug. 7, 2024.

(51) Int. Cl. G06Q 40/04

(52) U.S. Cl. CPC G06Q 40/0421

(57) ABSTRACT

Systems and methods for price discovery offering are disclosed. A method may include: receiving, by a computer program executed by an electronic device, an identification of an initial public offering (IPO); receiving, by the computer program, price discovery trading data comprising order placements and trades during a price discovery trading period; predicting, by the computer program, a demand expectation for the IPO based on the price discovery trading data, a sentiment for the IPO, and a momentum analysis for the IPO; pricing, by the computer program and using a machine learning model that is trained with historical data, the IPO based on the demand expectation and an IPO supply; receiving, by the computer program, public trading information for the IPO; and settling, by the computer program, the order placements and the trades during a price discovery training period.

### RELATED APPLICATIONS

This application claims priority to, and the benefit of, U.S. Patent Application Ser. No. 63/680,350, filed Aug. 7, 2025, the disclosure of which is hereby incorporated, by reference, in its entirety.

### BACKGROUND OF THE INVENTION

### 1. Field of the Invention

Embodiments relate to systems and methods for price discovery offering.

### 2. Description of the Related Art

Pricing initial public offerings (IPOs) is very difficult and inefficient, leading to a first day “pop”—a significant change in pricing between the first day of the IPO and the next day. There are two primary approaches for narrowing the difference between the offering price—the first day price—and that for public trading the day after the IPO. For example, a traditional IPO may involve “testing the waters” to gauge investor interest prior to availability of the prospectus and collecting non-binding bids from interested investors after the prospectus filing. As another example, direct listing may involve market-driven price discovery via secondary trading activity. Both approaches, however, often result in material price dislocations on the first day of public trading.

### SUMMARY OF THE INVENTION

Systems and methods for price discovery offering are disclosed. In one embodiment, a method may include: receiving, by a computer program executed by an electronic device, an identification of an initial public offering (IPO); receiving, by the computer program, price discovery trading data comprising order placements and trades during a price discovery trading period; predicting, by the computer program, a demand expectation for the IPO based on the price discovery trading data, a sentiment for the IPO, and a momentum analysis for the IPO; pricing, by the computer program and using a machine learning model that is trained with historical data, the IPO based on the demand expectation and an IPO supply; receiving, by the computer program, public trading information for the IPO; and settling, by the computer program, the order placements and the trades during a price discovery training period.

In one embodiment, the identification of the IPO and the price range for the IPO prior to the IPO are received from an Alternative Trading System.

In one embodiment, the method may also include receiving, by the computer program, investor roadshow information comprising investor meeting requests, attendance, questions posed in investor meetings, and online viewership and data from public sources, wherein the computer program further uses the investor roadshow information to predict the demand expectation.

In one embodiment, the IPO is priced a day before the IPO.

In one embodiment, the computer program uses a machine learning model trained on patterns the price discovery trading data and pricing of similar IPOs to price the IPO.

In one embodiment, the price discovery trading data comprises a price during the price discovery trading period, a volume traded during the price discovery trading period, bid/ask spreads, a frequency of trading during the price discovery trading period, a volatility level, a support level, a resistance level, and/or a moving average convergency/divergency.

In one embodiment, the machine learning model is further trained with a multi-modal training set comprising textual data from community networks, news outlets, science and research sources and numerical trading data.

In one embodiment, the machine learning model is trained using time series data, scenarios-based data and synthetic data created by simulation agents.

In one embodiment, the synthetic data mimics real-world buying and selling.

In one embodiment, the simulation agents simulate market participants.

According to another embodiment, a non-transitory computer readable storage medium may include instructions stored thereon, which when read and executed by one or more computer processors, cause the one or more computer processors to perform steps comprising: receiving an identification of an initial public offering (IPO); receiving price discovery trading data comprising order placements and trades during a price discovery trading period; predicting a demand expectation for the IPO based on the price discovery trading data, a sentiment for the IPO, and a momentum analysis for the IPO; pricing, using a machine learning model that is trained with historical data, the IPO based on the demand expectation and an IPO supply; receiving public trading information for the IPO; and settling the order placements and the trades during a price discovery training period.

In one embodiment, the identification of the IPO and the price range for the IPO prior to the IPO are received from an Alternative Trading System.

In one embodiment, the non-transitory computer readable storage medium may also include instructions stored thereon, which when read and executed by the one or more computer processors, cause the one or more computer processors to perform steps comprising: receiving investor roadshow information comprising investor meeting requests, attendance, questions posed in investor meetings, and online viewership and data from public sources.

In one embodiment, the IPO may be priced a day before the IPO.

In one embodiment, the IPO may be priced using a machine learning model trained on patterns the price discovery trading data and pricing of similar IPOs.

In one embodiment, the price discovery trading data may include a price during the price discovery trading period, a volume traded during the price discovery trading period, bid/ask spreads, a frequency of trading during the price discovery trading period, a volatility level, a support level, a resistance level, and/or a moving average convergency/divergency.

In one embodiment, the machine learning model may be further trained with a multi-modal training set comprising textual data from community networks, news outlets, science and research sources and numerical trading data.

In one embodiment, the machine learning model may be trained using time series data, scenarios-based data and synthetic data created by simulation agents.

In one embodiment, the synthetic data may mimic real-world buying and selling.

In one embodiment, the simulation agents may simulate market participants.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for price discovery offering according to an embodiment;

FIG. 2 depicts a method for price discovery offering according to an embodiment;

FIG. 3 depicts an exemplary computing system for implementing aspects of the present disclosure.

### DETAILED DESCRIPTION OF PREFERRED EMBODIMENTS

Systems and methods for price discovery offering are disclosed.

In embodiments, the debut offering in an IPO may be priced by combining the advantages of direct listings, and traditional IPOs.

For example, between the launch and before pricing the IPO (the “bookbuilding process”), a period of “price discovery trading” may be used. This period may demonstrate the prices at which real buyers and sellers are willing to transact. Settlement of price discovery trades are contingent on the IPO closing.

In embodiments, price discovery trading may supplement traditional IPO engagement with investors to build a more holistic view of the demand curve.

Using pre-offering price discovery, secondary trades may take place prior to the pricing of the IPO to facilitate price discovery. The seller may be pre-IPO investors and employees who would be permitted to monetize shares that will otherwise become subject to lock-up after the IPO. Buyers may build position in a “hot” offering where there is no assurance for full allocation.

In embodiments, price discovery offering may include the bookbuilding process for both primary and secondary shares. While only secondary shares are delivered to settle trades that take place in the price discovery market, the public offering that are priced at the end of the trading period can include both primary and secondary tranches. The issuer may reduce the IPO “pop” as pricing for bookbuild that takes into account the demand in the pre-offering market. Investors may have the option to both buy in the price discovery market and place orders in the bookbuild.

An example process is as follows. After the issuer publicly files a form (e.g., SEC Form S-1/A or SEC Form F-1/A (for non-US private issuers)), and several days after launching an IPO roadshow, a period of price discovery trading may take place (e.g., for approximately 2-4 days or for any other suitable period). In embodiments, only secondary shares are available for trading on this pre-IPO price discovery market.

Eligible sellers during the price discovery period may include holders of “free stock,” such as non-affiliates who have held for a minimum period of time (e.g., at least 12 months), including current and former employees, smaller angel investors, etc.

Buyers may include the same universe of investors that typically participate in IPOs.

Settlement of price discovery trades may be contingent on the IPO closing and may be concurrent with IPO settlement. This provides buyers in this pre-IPO market with the assurance that they are investing in a liquid security. If the IPO does not close, cash and shares do not change hands.

Buyers in the price discovery period may also be able to re-sell any shares they purchase, but such sales may also be contingent on the IPO closing.

In embodiments, trades may take place in a market and may use an Alternative Trading System (“ATS”). Price and volume data may be available, but the identities of buyers or sellers may not be. Thus, the same information that is used on public stock exchanges may be used.

Trades may be standard unsolicited brokerage transactions (agency-only, no principal) and limit orders only (no market orders).

The IPO may be priced a day after the final day of price discovery trading, and after markets close. The price and volume data from the price discovery trading period may be input into certain analytics to extrapolate a demand curve for quantum of investor demand at various price levels and may be taken into account in setting the IPO price.

In one embodiment, machine learning and/or artificial intelligence may be used to price the IPO. For example, patterns in investment, as well as pricing in similar IPOs, may be used to price the IPO. Factors that may be considered in pricing the IPO may include quantum, frequency, and momentum of bids and asks. These may be used to predict a demand expectation for the IPO, which impact the predicted price.

In another embodiment, pattern recognition and/or predictive modelling may be used to price the IPO. For example, pattern recognition or predictive model may be based on, for example, pricing during the price discovery trading period, volume traded during the price discovery trading period, bid/ask spreads, frequency of trading during the price discovery trading period, volatility, support and resistance levels, moving average convergency/divergency, and other momentum indicators from the price discovery trading period. These may also be used to predict the demand expectation for the IPO, which impact the predicted price.

Embodiments may further analyze “odd-lot” orders, which may be used to infer activity related to issuer's employees and angel investors versus institutional investors. These types of order may influence demand differently, as the issuer's employers and angel investors may have a different investment approach than institutional investors. For example, the issuer's employees may be able to monetize shares before the IPO, which others may not be able to do. Thus, the activity of these entities may be weighted differently than the activity of institutional investors.

Embodiments may price the IPO based on a comparative analysis of trading activity publicly traded equity securities, derivative instruments, indices and baskets thereof that may be deemed to be comparable to the issuer across dimensions that may include market capitalization, sector categorization, and financial and operational metrics. For example, the IPO may be priced similarly to similarly situated issuers.

Any suitable combination of any of these methods or techniques or factors may be used to price the IPO as is necessary and/or desired.

Shares sold in the IPO may be primary or secondary (or a combination), and banks may act in the same underwriting capacity in the IPO as a traditional IPO process.

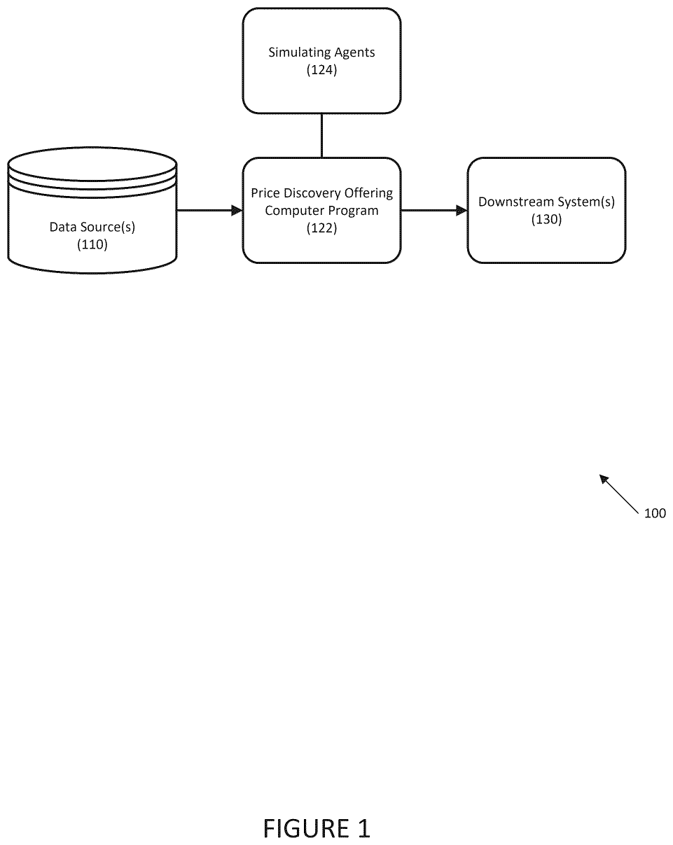

Referring to FIG. 1, a system for price discovery offering is provided according to an embodiment. System 100 may include data sources 110, which may include sources of market data, broker platforms, sources of historic orderbook allocations and regulatory filings made by institutional investors (e.g., Form 13D, Form 13F and Form 13G), ATSs, etc.

Other data sources 110 may include community networks, news outlets, science and research sources related to the IPO issuer and associated domain.

System 100 may further include price discovery offering computer program 122 may output permutations for clearing price at various offering sizes to downstream system(s) 130, such as trading systems (e.g., trading computer programs) that may place bids and asks on an agency basis during the price discovery trading period, orderbook allocation systems in the IPO, systems of underwriters placing stabilizing bids in the secondary market after the IPO using an overallotment option, etc.

Price discovery offering computer program 122 may provide a sentiment and momentum analysis and may output an interpolation market microstructure of trading patterns during price discovering trading period and an extrapolation of a demand curve for the IPO offering. The development of sentiment analysis may be based on text input from sources such as news articles, social media posts, product reviews as well as investor feedback from testing-the-waters and roadshow process to analyze variance in sentiment lexicon amongst market participant cohorts such as historic investors, employees, institutional long-only, hedge funds, short sellers and retail. Sentiment analysis informs the extrapolation of likely buying and selling behavior with associated quantum and size for various investor types.

Momentum analysis may be based on stock price, trading volume, bid/ask spreads, frequency, volatility level, support level, resistance level, and/or a moving average convergency/divergency during the price discovery period. The momentum analysis may be used to extrapolate trading behavior after the IPO.

System 100 may further include one or more simulating agents 124 that may simulate various market participants such as historic investors, employees, institutional long-only, hedge funds, short sellers and retail investors will be part of the system to train, stress-test and finetune the model to predict supply and demand. Simulating agents 124 may be computer programs that may be programmed or trained to generate synthetic data that may be used to train the model so that the model can predicted pricing.

For example, simulating agents may include autonomous AI agents that are designed with characteristics and prioritizations specific to each type of market participant (e.g., a simulating agent may simulate an employee with high percentage of net worth in the stock of the issuer, another simulating agent may simulate a portfolio manager for a long-only institutional investment firm that is measured on excess return versus benchmark index, etc.). Simulating agents 124 may be directed to place trade orders with specific price and volume with the goal of optimizing the outcome for the market participant which it is simulating.

The behavior of simulating agents 124 may evolve as they continuously learn from whether its prior trade order was filled, other observed trades that took place on the market, intaking new information and changes to the broader market environment.

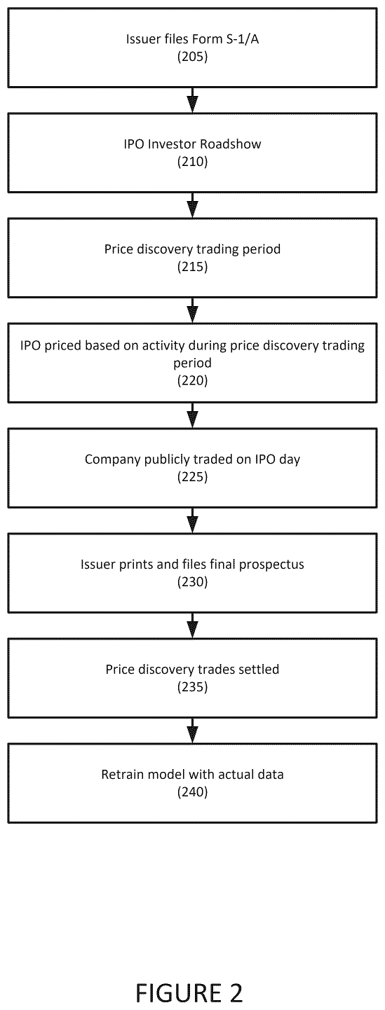

Referring to FIG. 2, a method for price discovery offering is provided according to an embodiment.

In step 205, an issuer may publicly file a form (e.g., S-1/A or F-1/A) with a price range with the Securities and Exchange Commission (“SEC”). This may be filed after markets close, approximately 8 days before the IPO target pricing date (“Day T-8”). The number of days is illustrative only, and greater or fewer days may be used.

In one embodiment, the filing of the form on Day T-8 may include language disclosing the availability of trading on a pre-IPO price discovery market.

ATSs currently facilitating trades of private secondary shares may provide regular communications announcing the debut of companies on their platforms. Upon filing of the form on Day T-8, an ATS may concurrently announce the upcoming availability of shares of the issuer on its platform and note that that shares will be available for trading for a limited period (e.g., days T-4 to T-2), and that the settlement will be contingent on the IPO closing and on closing, buyers will be receiving a listed security.

Because ATSs are typically inter-broker platforms, interested participants may have the option to transact through a broker they would typically use for trading of publicly listed shares, or transact directly through the ATS.

In one embodiment, the information may be provided to a computer program from eligible sellers during a price discovery period and from ATSs/brokerage platforms.

In step 210, an IPO investor roadshow may be provided. This may last from seven days before the IPO, to the day before the IPO. This may be similar to the traditional IPO process, and the issuer may share a publicly available investor presentation (e.g., via net roadshow).

The timing may vary as is necessary and/or desired.

In one embodiment, an underwriter or another party responsible for coordinating investor roadshow may input investor meeting requests, attendance, questions posed in investor meetings where brokers are permitted to attend, as well as online viewership into the computer program. The computer program may also ingest data from public sources, such as news outlets and community networks, during the investor roadshow period.

In step 215, price discovery trading may occur from T-4 to T-2. The timing may vary as is necessary and/or desired. In one embodiment, the computer program may connect to the ATS via, for example, an Application Programming Interface (“API”) to receive consolidated data stream of order placements and trades.

In step 220, the day before pricing of the IPO, and after market close, the IPO may be priced based on the price and volume data from the price discovery trading period, and any other information that may be used. In one embodiment, the computer program may use machine learning and/or artificial intelligence to price the IPO. For example, patterns in investment, as well as pricing in similar IPOs, may be used to price the IPO. Factors that are considered may include quantum, frequency, sentiment, and momentum of bids and asks. The machine learning model may be trained with historical data to predict the demand expectation for the IPO given the supply of the IPO.

In one embodiment, machine learning and/or artificial intelligence may be used to price the IPO. For example, patterns in investment, as well as pricing in similar IPOs, may be used to price the IPO. Factors that may be considered in pricing the IPO may include quantum, frequency, and momentum of bids and asks. These may be used to predict a demand expectation for the IPO, which impact the predicted price.

In one embodiment, the machine learning model may be trained using multi-model training to combine textual data from community networks, news outlets, science and research sources with numerical trading data to create a multi-modal training set to enable to model to better understand the relationship between sentiment and market movements. For example, the machine learning model may be trained with historic information, such as demand information, sentiment analysis, similarly situated issuers, etc. to predict pricing of the IPO.

In addition, the computer program may focus the training on both time-series data and scenarios-based data into the training process to allow the model to understand how IPOs in different market conditions evolve over time in order to enhance the predictive abilities of the model.

A time-series model may be trained using sequential historic data including stock price, trading volume, bid/ask spreads, frequency, volatility level, support level, resistance level, and/or a moving average convergency/divergency to predict post-IPO trading in environments where historic relationships and correlations hold. The training may incorporate techniques, such as autoregressive integrated moving average (ARIMA) and exponential smoothing, that are designed to handle sequential data.

The time-series model may be supplemented by a scenarios-based model that trained on data structured around different types of market shocks (e.g., regulatory changes). Techniques for the scenario-based model may include simulation, optimization and decision-trees that can handle complex interactions across multiple variables.

For example, the training may incorporate ensemble methods to combine predictions from multiple models to capture patterns that may not have existed in a single set of historical data. The training process may also implement adaptive learning techniques where the model will continuously learn from new data and updates its parameters accordingly. For example, the output of the scenarios-based model may be superimposed on the predictions of the time-series model. The weight of the scenarios-based model may increase relative to the time-series model in market conditions where historic relationships and correlations break down (e.g., regulatory change that causes a step change in valuation across the broader equity market).

In another embodiment, pattern recognition and/or predictive modelling may be used to price the IPO. For example, pattern recognition or predictive model may be based on, for example, pricing during the price discovery trading period, volume traded during the price discovery trading period, bid/ask spreads, frequency of trading during the price discovery trading period, volatility, support and resistance levels, moving average convergency/divergency, and other momentum indicators from the price discovery trading period. These may also be used to predict the demand expectation for the IPO, which impact the predicted price.

Embodiments may further analyze “odd-lot” orders, which may be used to infer activity related to issuer's employees and angel investors versus institutional investors. These types of order may influence demand differently, as the issuer's employers and angel investors may have a different investment approach than institutional investors. For example, the issuer's employees may be able to monetize shares before the IPO, which others may not be able to do. Thus, the activity of these entities may be weighted differently than the activity of institutional investors.

Embodiments may price the IPO based on a comparative analysis of trading activity publicly traded equity securities, derivative instruments, indices and baskets thereof that may be deemed to be comparable to the issuer across dimensions that may include market capitalization, sector categorization, and financial and operational metrics. For example, the IPO may be priced similarly to similarly situated issuers.

In one embodiment, information from the roadshow, such as investor viewership and feedback, may be considered as a demand expectation that may be used in pricing the IPO. For example, the demand expectation may be increased based on a large viewership and positive feedback.

Embodiments may incorporate the use of fine-tuning small language models, collaborative filtering and adaptive learning to expand the model's understanding of with domain-specific concepts and interpret evolving jargon used in domain-specific communities. For example, online communities on investing may frequently use the term “HODL”, which is an intentional misspelling of “HOLD” popularized in Bitcoin investing, to express commitment to holding onto a position amid market volatility. The small language model may be finetuned to identify both the intentional misspelling and the affiliation of this term with investing behavior popular among those active in online forums.

In one embodiment, simulating agents may be used to represent various types of market participants. The simulating agents may create synthetic data that mimics real-world buying and selling action, allowing the machine learning model to construct a more holistic demand curve that takes into account types of activity by investors with tendency to be less active during the price discovery trading period prior to the IPO, which may skew more heavily towards hedge funds that regular-way trading after the IPO.

For example, simulating agents may include autonomous AI agents that are designed with characteristics and prioritizations specific to each type of market participant (e.g., a simulating agent may simulate an employee with high percentage of net worth in the stock of the issuer, another simulating agent may simulate a portfolio manager for a long-only institutional investment firm that is measured on excess return versus benchmark index, etc.). The simulating agents may be directed to place trade orders with specific price and volume with the goal of optimizing the outcome for the market participant which it is simulating.

The data from the simulating agents may be used to predict demand and supply curves under various market environments, thereby creating a series of clearing prices at various IPO offering sizes that an issuer and underwriters use to set the IPO price.

In step 225, on the pricing day of the IPO, the company may be publicly traded. For example, the computer program may connect by, for example, API, to a consolidated data stream to ingest data on opening trade and subsequent trading on the stock exchange.

In step 230, on the day after pricing of the IPO, the issuer may print and file its final prospective, as in a traditional IPO process. The computer system may receive regulatory filing data, including the final prospectus as well as subsequent public data sources reporting on the IPO.

In step 235, one full trading day after pricing of the IPO, the IPO, as well as the price discovery trades, may be settled. The settlement and clearing process would take place via standard processes, such as the Depository Trust Company (DTC), for listed equity securities.

In step 240, after settlement, the model may be trained with actual pricing data so that the model may be made available to other IPOs.

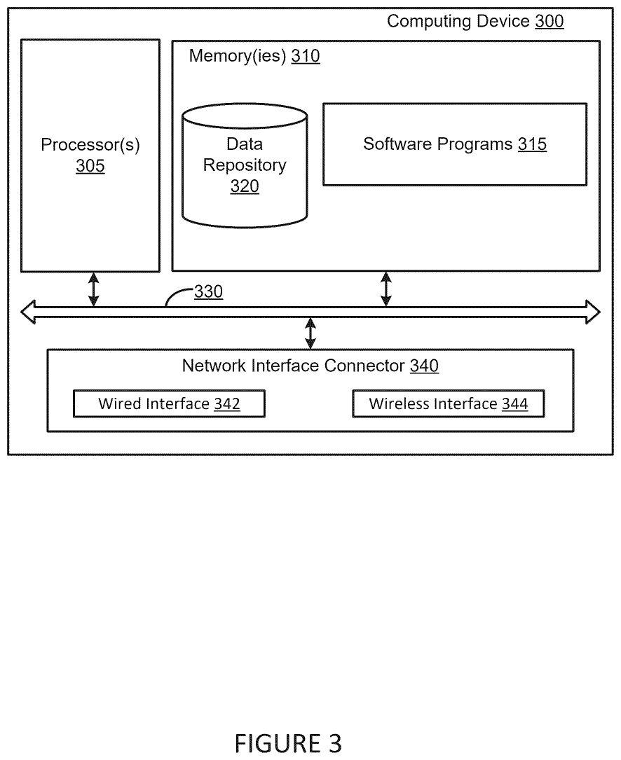

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device, an identification of an initial public offering (IPO);
receiving, by the computer program, price discovery trading data comprising order placements and trades during a price discovery trading period;
predicting, by the computer program, a demand expectation for the IPO based on the price discovery trading data, a sentiment for the IPO, and a momentum analysis for the IPO;
pricing, by the computer program and using a machine learning model that is trained with historical data, the IPO based on the demand expectation and an IPO supply;
receiving, by the computer program, public trading information for the IPO; and
settling, by the computer program, the order placements and the trades during a price discovery training period.

2. The method of claim 1, wherein the identification of the IPO is received from an Alternative Trading System.

3. The method of claim 1, further comprising:
receiving, by the computer program, investor roadshow information comprising investor meeting requests, attendance, questions posed in investor meetings, and online viewership and data from public sources, wherein the computer program further uses the investor roadshow information to predict the demand expectation.

4. The method of claim 1, wherein the step of pricing, the IPO based on the demand expectation and an IPO supply occurs a day before the IPO is offered for public trading.

5. The method of claim 1, wherein the machine learning model is trained on patterns from the price discovery trading data and pricing of similar IPOs to price the IPO.

6. The method of claim 5, wherein the price discovery trading data comprises a price during the price discovery trading period, a volume traded during the price discovery trading period, bid/ask spreads, a frequency of trading during the price discovery trading period, a volatility level, a support level, a resistance level, and/or a moving average convergency/divergency.

7. The method of claim 5, wherein the machine learning model is further trained with a multi-modal training set comprising textual data from community networks, news outlets, science and research sources and numerical trading data.

8. The method of claim 5, wherein the machine learning model is trained using time series data, scenarios-based data and synthetic data.

9. The method of claim 8, wherein simulating agents are configured to generate the synthetic data that mimics real-world buying and selling.

10. The method of claim 9, wherein the simulating agents comprise artificial intelligence agents that are configured to simulate market participants.

11. A non-transitory computer readable storage medium, including instructions stored thereon, which when read and executed by one or more computer processors, cause the one or more computer processors to perform steps comprising:
receiving an identification of an initial public offering (IPO);
receiving price discovery trading data comprising order placements and trades during a price discovery trading period;
predicting a demand expectation for the IPO based on the price discovery trading data, a sentiment for the IPO, and a momentum analysis for the IPO;
pricing, using a machine learning model that is trained with historical data, the IPO based on the demand expectation and an IPO supply;
receiving public trading information for the IPO; and
settling the order placements and the trades during a price discovery training period.

12. The non-transitory computer readable storage medium of claim 11, wherein the identification of the IPO and the price range for the IPO prior to the IPO are received from an Alternative Trading System.

13. The non-transitory computer readable storage medium of claim 11, further including instructions stored thereon, which when read and executed by the one or more computer processors, cause the one or more computer processors to perform steps comprising:
receiving investor roadshow information comprising investor meeting requests, attendance, questions posed in investor meetings, and online viewership and data from public sources;
wherein demand is further predicted using the investor roadshow information.

14. The non-transitory computer readable storage medium of claim 11, wherein the IPO is priced a day before the IPO.

15. The non-transitory computer readable storage medium of claim 11, wherein the IPO is priced using a machine learning model trained on patterns the price discovery trading data and pricing of similar IPOs.

16. The non-transitory computer readable storage medium of claim 15, wherein the price discovery trading data comprises a price during the price discovery trading period, a volume traded during the price discovery trading period, bid/ask spreads, a frequency of trading during the price discovery trading period, a volatility level, a support level, a resistance level, and/or a moving average convergency/divergency.

17. The non-transitory computer readable storage medium of claim 15, wherein the machine learning model is further trained with a multi-modal training set comprising textual data from community networks, news outlets, science and research sources and numerical trading data.

18. The non-transitory computer readable storage medium of claim 15, wherein the machine learning model is trained using time series data, scenarios-based data and synthetic data created by simulating agents.

19. The non-transitory computer readable storage medium of claim 18, wherein the synthetic data mimics real-world buying and selling.

20. The non-transitory computer readable storage medium of claim 18, wherein the simulating agents simulate market participants.
